(19) United States
(12) Patent Application Publication
(10) Pub. No.: US 2010/0293804 A1
(43) Pub. Date: Nov. 25, 2010

(54) DRYER HAVING HEAT PUMP AND FAN

(75) Inventors: Thomas Nawrot, Berlin (DE); Günter Steffens, Dallgow-Doberitz (DE); Andreas Ziemann, Potsdam (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/812,472

(22) PCT Filed: Dec. 19, 2008
(86) PCT No.: PCT/EP08/68035

§ 371 Date: Jul. 12, 2010

(30) Foreign Application Priority Data
Jan. 15, 2008 (DE) 10 2008 004 457.1

(51) Int. Cl. F26B 19/00; D06F 58/04; F25B 27/02

(52) U.S. Cl. 34/86; 34/130; 62/238.7

(57) ABSTRACT

A dryer having a drying chamber for items to be dried; a process air guide; a fan to deliver an air stream in the process air guide; and a heat pump that has a heat sink and a heat source; wherein the heat sink and the heat source are arranged in the process air guide; and wherein the fan has double pipes.

Dryer with a drying chamber for items to be dried, a process air guide, a fan for delivering a stream of air in the process air guide and a heat pump comprising a heat sink and a heat source, which are both arranged in the process air guide.

Such a dryer, embodied as a tumble dryer, follows from an abstract of JP 2004 089415 A contained in the database “Patent Abstracts of Japan”.

In general a tumble dryer is operated as an exhaust air dryer or as a condensation dryer. An exhaust air dryer directs heated air once through the laundry to be dried and delivers this with moisture-laden air through an exhaust air hose from the exhaust air dryer and out of the room in which it is set up. A condensation dryer, the functional method of which relies on the condensation of the moisture evaporated out of the laundry by means of warm process air, requires no exhaust air hose and enables energy recovery from the heated process air, for example through the use of a heat pump.

A dryer with heat recovery follows from DE 30 00 865 A1. A so-called exhaust air dryer is described therein, which heats a stream of air in an open duct once and delivers it through the laundry to be dried and then expels it from the duct. The heat recovery takes place by means of a simple heat exchanger, in that heat from the process air to be expelled is transferred to the process air which has newly inflowed. The process air warmed in the heat exchanger is further heated by means of a heater and then reaches the items of laundry to be dried.

At least one fan is generally arranged in a dryer, which is embodied to deliver the stream of air.

In the case of a tumble dryer, which is embodied with a heat pump to reduce the energy consumption, the air flow rate according to the throughput of the stream of air in the process air guide is an operationally limiting factor. In this connection a customary known fan enables no greater delivery. Also as a result of the single-motor concept implemented according to DE 10 2006 002 713 A1 in a dryer in particular on grounds of cost, an increase in air flow rate is only possible to a limited degree. Within the framework of the single-motor concept according to this document a single motor in a conventional dryer serves for the joint driving of the process air fan, a cooling air fan and the drum, which accommodates items of laundry to be dried.

It is the object of the present invention to create a dryer in which the air flow rate to be delivered can be increased.

This object is achieved by a dryer which has the features according to the independent claim.

An inventive dryer with a drying chamber for items to be dried, a process air guide, a fan for delivering a stream of air in the process air guide and a heat pump comprising a heat sink and a heat source, which are both arranged in the process air guide, is characterized in that the fan is embodied to have double pipes.

By means of an embodiment of this kind the air flow rate of the dryer can be significantly increased and thus the volume flow delivered boosted.

In principle, any heat pump can be employed in the dryer. An advantage of the heat pump lies in the fact that temperature levels for the cooling or heating of the process air can be selected with a certain independence from each other. By adjusting the pumping behavior of the heat pump, by which is meant the relationship between pumped heat output and the power used therein, it is also possible to effect any extra heating of the process air which may be necessary; the unavoidable fact of the restricted efficiency of a heat pump is thus exploited as a further advantage.

The double pipe embodiment of the fan is preferably realized by one component, which accommodates a multiplicity of impellers in one housing. To this end, the double pipe embodiment of the fan is functionally preferably embodied like a coupling in parallel of two individual auxiliary fans, that is like two auxiliary fans driven in parallel with each other. This guarantees a particularly effective boosting of the volume flow.

The double pipe fan is preferably coupled flow-wise with the process air guide at two different sections. In particular the fan is coupled with the process air guide upstream and downstream of the drying chamber in the direction of flow of the stream of air.

Likewise preferably, the double pipe fan comprises two separate auxiliary fans, which in each case have a separate pressure chamber, where the pressure chambers are separated from each other pressure-wise.

Also preferably, the two auxiliary fans can be driven via a common shaft by means of a motor. To further advantage, the drying chamber embodied as a rotatable drum is also driven by this motor.

By means of these embodiments, a single-motor concept can be realized in the dryer, which means that a fan with a multiplicity of separate auxiliary fans and the drum can be driven with a motor. An embodiment of the dryer which saves on components can thereby be achieved and additionally also a reduction in cost. In addition by means of the embodiment a motor with a relatively short shaft on just one side can be employed.

Further preferable is an inventive dryer, in which by means of a first auxiliary fan air can be sucked into the dryer and delivered via the heat source to the drying chamber, and by means of a second auxiliary fan the stream of air emerging from the drying chamber delivered via the heat sink from the dryer to the outside. A good and functionally appropriate distribution of the auxiliary fans over the process air guide between the functional components of the heat pump is thus achieved.

It proves to be particularly preferable if the heat pump has a choke and a compressor as well as a pipe system for the circulation of a working fluid through the heat sink embodied as an evaporator for the working fluid and the heat source embodied as a liquefier for the working fluid. In such a dryer, the cooling of the warm, moisture-laden process air is essentially achieved in the evaporator of the heat pump, where the transferred heat is used for the evaporation of a working fluid or refrigerant employed in the heat pump circuit. The working fluid evaporated as a result of the heating is fed via the compressor to the liquefier of the heat pump, where as a result of the condensation of the gaseous working fluid heat is given off, which is used to heat the stream of air in the process air guide. The working fluid circulates in a closed circuit, in which it moves from the liquefier via a choke back to the evaporator.

In the heat pump just described, a working fluid is preferably used, which is selected from a group comprising the refrigerants R134a, R152a, R290, R407C and R410A. All the cited working fluids except R290 are fluorinated hydrocarbons or mixed fluorinated hydrocarbons; in the case of R290 this takes the form of hydrocarbon propane, which although relatively easily flammable, would be very suitable as the working fluid in the present connection due to its technical properties, as well as being highly environmentally compatible.

Likewise preferably, in the inventive exhaust air dryer a flow regulator is assigned to the process air guide, where the flow regulator is further preferably arranged between the fan and the heat source. It is particularly preferable that the flow regulator is a flap. With this flow regulator, control of the stream of air in the process air guide is possible. Depending on the nature of the items of laundry to be dried or the status of a drying process, it is possible, by reducing the stream of air, where the heating by means of the heat source and/or the heater remains the same, to achieve an increase in the temperature of the stream of air during its passage through drying chamber with the items to be dried. Thereby for example an accelerated heating of the process air guide and the items to be dried at the start of a drying process, and thus overall reduced time requirements for the drying process, can be achieved. Likewise, if the nature of the items of laundry presented for drying allows, a drying process can take place at a higher than customary temperature, which likewise permits an acceleration of the drying process.

The dryer is preferably embodied as an exhaust air dryer, and thus has an open process air guide. This means that the duct system of the process air guide does not direct the process air in a circuit, but expels it in the stream out of the dryer.

Further advantageous embodiments are evident from the dependent claims.

Exemplary embodiments of the invention are explained in detail as follows on the basis of the attached schematic drawing.

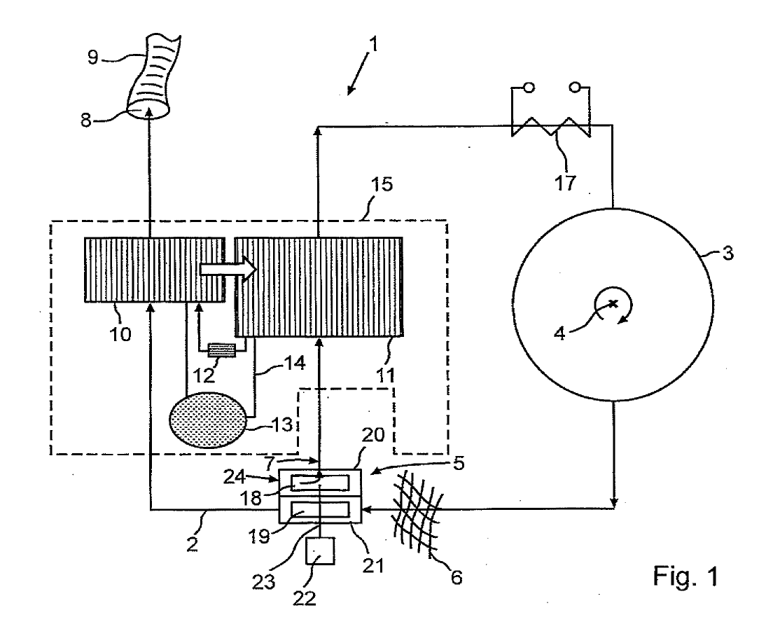

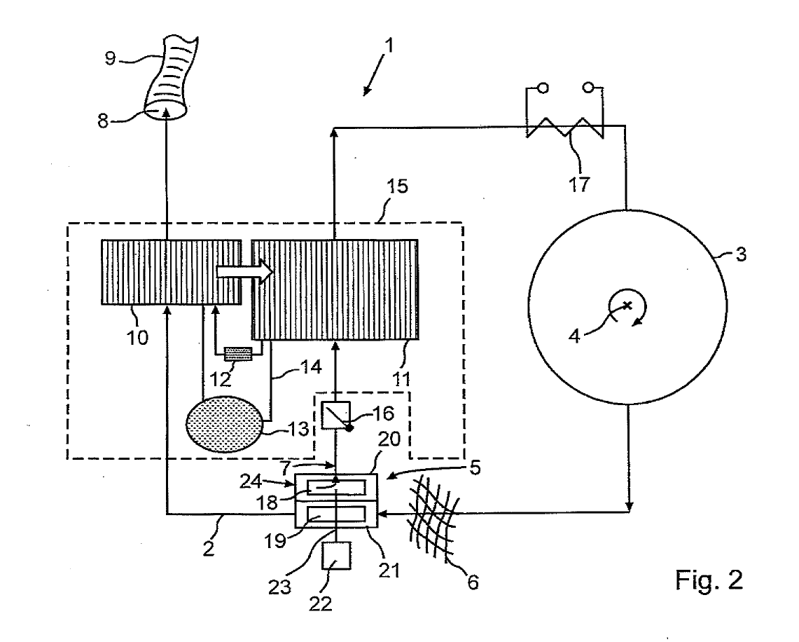

FIG. 1 and FIG. 2 each case show a dryer with a double pipe fan in a simplified representation.

It is pointed out that the items from FIGS. 1 and 2 differ only in the object with the reference number 16, to which further reference will be made below. Initially the explanation of the two figures will take place jointly.

The dryer 1 represented in FIG. 1 or FIG. 2 is embodied as an exhaust air dryer 1, and has a process air guide 2 to guide the required process air, also occasionally designated a process air channel 2. In addition the dryer 1 comprises a drum 3 as a drying chamber 3, into which items of laundry to be dried are introduced. The drum 3 is mounted rotatably around an axis of rotation 4 oriented perpendicularly to the plane of the figure according to the arrow representation. Process air flowing in the process air guide 2 is directed by means of a double pipe fan 5 through the drum 3 and the items of laundry contained therein (not shown here). In the direction of the stream of air in the process air guide 2 according to arrowed representation, after the drum 3 this flows through a fluff filter 6, which in the simplest case is a grid-like sieve 6. By means of the fluff filter 6 fluff, which comprises small fibers which are dislodged from the items of laundry by the process air and carried along with it, are trapped or filtered out. The position of the fluff filter 6 in the process air guide 2 according to the representation is solely by way of example, which means that the fluff filter 6 can also be arranged at a different location.

The process air or the stream of air is sucked from outside the dryer 1 through an air inlet aperture 7 by means of the fan 5, drawn into the process air channel 2 and expelled from the dryer 1 through an exhaust air outlet 8. Connected to this exhaust air outlet 8 is an exhaust air hose 9, with which the exhaust air can be extracted from the dryer 1 and discharged out of a building in which it is set up.

In addition the dryer 1 comprises a heat pump 15 comprising the heat sink 10 and the heat source 11, where the heat source 11 is a liquefier 11 in the heat pump 15. The heat sink 10 is an evaporator 10 of this heat pump 15. The heat pump 15 additionally comprises a choke 12 and a compressor 13, which like the liquefier 11 and the evaporator 10 are coupled with a closed pipe system 14 to form a circuit for working fluid. A refrigerant known under the designation R407C serves as the working fluid. Driven by the compressor 13, the working fluid is cyclically evaporated, compressed, liquefied and expanded. Gaseous working fluid leaving the evaporator 10 is compressed by the compressor 13 and heated. It then reaches the liquefier 11, where it is liquefied, while giving off heat to the process air. It subsequently flows in the pipe system 14 through the choke 12, where it is expanded to a lower pressure, and reaches the evaporator 10, where it is evaporated out of the process air, with heat being absorbed. From the evaporator 10 it flows in the pipe system 14 back to the compressor 13, so that the circuit is closed.

A heating device 17 can be arranged in the process air guide 2 or in the process air channel 2 between the liquefier 11 and the entrance to the drum 3.

The double pipe fan 5 is embodied as a one-piece component, having a housing, in which two separate auxiliary fans 18 and 19, here, in the case of the embodiment as a radial fan, the halves of the impeller 18 and 19, are arranged. The first half of the impeller 18 is arranged in a first pressure chamber 20, while the second half of the impeller 19 is arranged in a second pressure chamber 21. The two pressure chambers 20 and 21 are separated from each other flow-wise. In addition the double pipe fan 5 is coupled on the one hand with the process air guide 2 upstream of the liquefier 11 and on the other hand with the process air guide 2 or the process air channel 2 respectively, downstream of the drum 3 and upstream of the evaporator 10. In this connection the first pressure chamber 20 and the first half of the impeller 18 are coupled flow-wise with the process air guide upstream of the liquefier 11 and the second half of the impeller 19, and the second pressure chamber 21 with the process air guide upstream of the evaporator 10.

The double pipe fan 5 is designed structurally as if two separate individual fans were connected in parallel or coupled with the aim of enabling common drive.

Through the ingenious coupling with different areas of the process air guide 2 and the compact structural form in one housing it is additionally realized that both auxiliary fans 18 and 19 are driven by a single motor 22 via a common shaft 23. By means of this single-motor concept, a relatively short shaft 23 can be employed on just one side of the fan 5. The motor 22 also drives the drum 3 via a corresponding transmission and a corresponding drive belt.

By means of the double pipe fan 5 a significant increase in the volume flow can be guaranteed, and longer exhaust air pipes can be enabled. In addition an improvement in the operating effectiveness of the dryer 1 can be guaranteed. In addition the waste heat from the motor 22 can be used, which is advantageous from the energy-related perspective.

Functionally speaking, during operation of the double pipe fan 5, air can be ingested from outside the dryer 1 through the air inlet 24 via the auxiliary fan 18 and the pressure chamber 20 and sucked in via the air inlet aperture 7 of the process air guide 2 and delivered onward. The ingested air is then guided through the liquefier 11. In the liquefier 11 the process air or the stream of air respectively are heated. By means of the heating device 17, further heating can be provided prior to its introduction. Depending on the size and dimensioning of the heat pump 15, the heating device 17 may be present or not, as the case may be.

The air thus heated and directed into the drum 3 there comes into contact with the laundry to be dried and flows thereafter to the fluff filter 6. The moist, warm and possibly fluff-free process air is directed through the double pipe fan 5 and there in particular through the second pressure chamber 21, and delivered onward through the second auxiliary fan 19 to the evaporator 10. The process air is cooled in the evaporator 10. The heat hereby removed from the process air is delivered in the heat pump circuit 15 to the liquefier 11 and there fed to the freshly ingested process air. The then cooled air is then directed out of the dryer 1 to the outside via the exhaust air outlet 8. It should be noted that condensate may condense out from the stream of air in the process air guide 2 in the area of the evaporator 10, as a result of condensation of the moisture it also carries; such condensation forms due to cooling of the process air. Accordingly it should be ensured that such condensate is securely captured and can be disposed of. Corresponding means and measures are not represented in the present case; they can in principle be embodied according to those means and measures, which are known as being relevant for corresponding purposes in condensation dryers.

While in the case of the subject matter of FIG. 1 it is provided for the process air to be delivered in all cases with two auxiliary fans 18 and 19, in the case of the subject matter of FIG. 2 an additional flow regulator 16 in the form of a flap 16 is provided. As shown in FIG. 2, the flap 16 can be a simple choke flap, which partially shuts off the process air guide 2. Alternatively, the flap can also be embodied in such a way that, by shutting the auxiliary fan 18 off from the process air guide, it releases a second air inlet, through which even in the case of a completely shut-off auxiliary fan 18, process air can enter the process air guide 2.

With this flap 16 the process air guide 2 can be partially closed and in this manner the delivery effect of the auxiliary fan 18 can be restricted, or even excluded. In this way control of the stream of air in the process air guide 2 is possible. Depending on the nature of the items of laundry to be dried or the status of a drying processes, by reducing the stream of air while the heating by means of the heat source 11 and/or the heater 18 remains the same, it is possible to achieve an increase in the temperature of the stream of air during its passage through the drying chamber with the items to be dried. Thereby for example an accelerated heating of the process air guide 2 and the items to be dried at the start of a drying process, and thus overall reduced time requirements for the drying process can be achieved. Likewise, if the nature of the items of laundry presented for drying allows, a drying process can take place at a higher than customary temperature, which likewise permits an acceleration of the drying process.

Not shown, but of course present, is a control device, which on the one hand informs a user of the dryer 1 about possible prescribed drying programs and accepts control commands from this user and on the other hand supplies the corresponding active components of the dryer 1 with energy and operating-related information, and receives operationally-relevant measurement data from corresponding sensors which are likewise present, and determines therefrom the operationally-relevant information for controlling the components named.

1-14. (canceled)

15. A dryer, comprising:
a drying chamber for items to be dried;
a process air guide;
a fan to deliver an air stream in the process air guide; and
a heat pump having a heat sink and a heat source, the heat sink and the heat source arranged in the process air guide;
wherein the fan has double pipes.

16. The dryer of claim 15, wherein the double pipes of the fan are functionally comparable to a parallel coupling of two auxiliary fans.

17. The dryer of claim 15, wherein, flow-wise, the fan is coupled with the process air guide at two different sections.

18. The dryer of claim 17, wherein, in a flow direction of the air stream, the fan is coupled with the process air guide upstream and downstream of the drying chamber.

19. The dryer of claim 15, wherein the fan has two separate auxiliary fans; and wherein each of the two separate auxiliary fans has a pressure chamber that are separated from each other pressure-wise.

20. The dryer of claim 19, further comprising a motor to drive the two separate auxiliary fans via a common shaft.

21. The dryer of claim 20, wherein the drying chamber is a drum that is rotatable by the motor.

22. The dryer of claim 15, further comprising a first auxiliary fan to ingest air from the outside into the dryer and to deliver the air to the drying chamber via the heat source, and a second auxiliary fan to deliver the air stream emerging from the drying chamber out of the dryer to the outside via the heat sink.

23. The dryer of claim 15, wherein the heat pump has a choke, a compressor and a pipe system to circulate a working fluid through the heat sink and the heat source; wherein the heat sink is an evaporator for the working fluid; and wherein the heat source is a liquefier for the working fluid.

24. The dryer of claim 23, wherein the working fluid is a refrigerant selected from the group consisting of R134a, R152a, R290, R407C and R410A.

25. The dryer of claim 15, further comprising a flow regulator and an air inlet duct, wherein the flow regulator is assigned to the air inlet duct.

26. The dryer of claim 25, wherein the flow regulator is arranged between the fan and the heat source.

27. The dryer of claim 25, wherein the flow regulator is a flap.

28. The dryer of claim 15, wherein the process air guide is open, and wherein the dryer is an exhaust air dryer.
